(19) United States
(12) Patent Application Publication
(10) Pub. No.: US 2008/0299512 A1
(43) Pub. Date: Dec. 4, 2008

(54) Duncan implant positioning tool

(76) Inventor: Gary Allan Duncan, Dublin, OH (US)

Correspondence Address: Mr. Gary Allan Duncan, 8831 Locherbie Court, Dublin, OH, 43017, US

(21) Appl. No.: 11/807,360

(22) Filed: May 29, 2007

(51) Int. Cl. A61C 13/36

(52) U.S. Cl. 433/74

(57) ABSTRACT

The Duncan Positioning Tool will assist in the process that will allow a surgeon to place a final dental implant restoration immediately after surgery into a patient's mouth that will function in conjunction with the dental implant(s) placed in the mandible and/or maxilla bone(s). The Duncan Positioning Tool is used in the manufacturing of a surgical dental implant stent that will allow a surgeon to place a dental implant(s) perfectly parallel to other dental implant(s) as well as teeth. The Positioning Tool is used in the manufacturing of a surgical dental implant stent that will allow a surgeon to place dental implant(s) at a predetermined depth within the mandible and/or maxilla of a patient undergoing surgery.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE, A TABLE, OR A COMPUTER PROGRAM LISTING COMPACT DISK APPENDIX

Not Applicable

### BACKGROUND OF THE INVENTION

The Duncan Implant Positioning Tool is placed into use during the first step of the process of manufacturing a surgical dental implant stent and is suggested to be placed under Class 433, Dentistry, as this class is a specific class under the broader class of Surgery and includes methods directed to or including specific dental steps whereas the use of this device ultimately facilitates the replacement teeth. The Duncan Implant Positioning Tool is suggested to be assigned the Subclass 25, Apparatus, whereas this device or subcombination thereof is for facilitating the replacement, treatment, or testing of either natural of artificial teeth noting that the above apparatus does not remain in the patient's mouth after treatment.

The Duncan Implant Positioning Tool is placed into use during the first step in solving notable problems in the process of both favorably manufacturing a surgical dental implant stent in the dental lab as well as ultimately surgically placing dental implants in the patients mouth using the aforementioned stent. Because the Duncan Positioning Tool or anything to serve it's exact purpose have not previously been invented, currently dental implant stents in addition to any other means used by surgeons to place any number of dental implants in a patient's mouth are unable to be manufactured as to allow such surgeons to place a dental implant parallel to other implants or existing teeth on the arch of the mandible or maxilla of the patient, are unable to be manufactured as to allow such surgeons to place a dental implant at a predetermined depth decided upon by the surgeon, therefore the final dental implant restoration will be immediately placed into the patient's mouth after surgery.

### BRIEF SUMMARY OF THE INVENTION

The Duncan Implant Positioning Tool is placed into use during the first step of manufacturing a dental implant stent. This tool is used in conjunction with a common surveyor which allows all dental implant analogs to be placed parallel to each other and to teeth on a patient's mandible or maxilla arch. This tool assists in allowing the ultimate manufacture a dental implant stent that for the first time will allow a surgeon to control the depth of a final dental implant placed in a patient's mouth and will allow a surgeon to place the final dental implant restoration immediately into the patients mouth in conjunction with the dental implant(s) placed while using the surgical stent.

### BRIEF DESCRIPTION OF THE SEVERAL VIEWS OF THE DRAWING

FIG. 1 is a front view perspective of the Duncan Implant Positioning Tool;

FIG. 2 is a side view perspective of the Duncan Implant Positioning Tool.

### DETAILED DESCRIPTION OF THE INVENTION

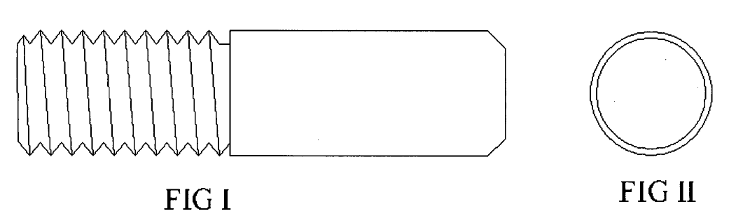

The Duncan Implant Positioning Tool is best carried out while used in conjunction with a common surveyor to place a dental implant analog parallel to other prescribed or existing analogs in a stone model made from impressions of a patients mandible or maxilla arch taken by a dentist. Referring to FIG. 1, the smooth end of the tool is placed into the surveyor while the threaded end is threaded into a dental implant analog with mating threads so that the analog can be placed into the model representing the patient's mandible or maxilla arch. Referring to FIG. 2, the threaded end of the Duncan Implant Positioning Tool is blunted and not hollow forming a solid dense unit.

The Duncan Implant Positioning Tool is the first of it's kind and is machined out of any surgical metal such as stainless steel or titanium while serving as the best way to carry out the manufacturing of this invention.

What is hereby claimed is:

1. The Duncan Implant Positioning Tool is a device that will position a dental implant analog into any model made of standard dental lab material which replicates a patient's mandible or maxilla.

2. The device defined in claim 1 will place all implant analogs parallel on the model.

3. The device defined in claim 1 will place all implant analogs on model at required depth.

4. The Duncan Implant Positioning Tool will work in conjunction with any common surveyor.

5. The device defined in claim 1 will position a dental implant analog in accordance to angles of other teeth when placing single analog along a mandible or maxilla ridge.

6. The device defined in claim 1 will allow for the manufacturing of a surgical dental implant stent that will allow a surgeon to place the final dental implant restoration immediately after surgery into a patient's mouth that will function in conjunction with the dental implant(s) placed in the mandible and/or maxilla bone(s) while using the aforementioned surgical dental implant stent.
